(19) United States
(12) Patent Application Publication
(10) Pub. No.: US 2014/0230626 A1
(43) Pub. Date: Aug. 21, 2014

(54) ACCESSORIES FOR OSCILLATING POWER TOOLS

(71) Applicant: Black & Decker Inc., Newark, DE (US)

(72) Inventors: Daniel PUZIO, Baltimore, MD (US); Scott M. RUDOLPH, Aberdeen, MD (US)

(73) Assignee: Black & Decker Inc., Newark, DE (US)

(21) Appl. No.: 14/264,615

(22) Filed: Apr. 29, 2014

Related U.S. Application Data
(63) Continuation of application No. PCT/US2012/065190, filed on Nov. 15, 2012.
(60) Provisional application No. 61/560,998, filed on Nov. 17, 2011.

(51) Int. Cl. B23D 61/00

(52) U.S. Cl. CPC B23D 61/006
USPC 83/697

(57) ABSTRACT

A blade for use with an oscillating power tool includes a blade body having a front portion and a rear portion. A working portion is coupled to the front portion of the blade body and is configured to remove material from a workpiece. A tool attachment portion is coupled to a rear portion of the blade body and is configured to be removably attachable to an oscillating power tool. A vibration reduction member is coupled to the blade body and configured to dampen vibration in the blade body.

### CROSS REFERENCE TO RELATED APPLICATIONS

This application claims priority, under 35 U.S.C. §§120 and 365(c), to PCT Application No. PCT/US2012/065190, filed Nov. 15, 2012, titled “Accessories for Oscillating Power Tool,” which PCT application claims priority, under 35 U.S.C. §119(e), to U.S. Provisional Patent Application No. 61/560,998, filed Nov. 17, 2011, titled “Oscillating Tools and Accessories.” Each of the aforementioned applications is incorporated by reference in its entirety.

### TECHNICAL FIELD

This application relates to accessories for oscillating power tools, such as oscillating saw blades, cutting blades, abrasives, sanding platens, pads and papers, rasps, and scrapers.

### BACKGROUND

Oscillating power tools comprise power tools with an output shaft that oscillates about its axis. Various types of accessories may be coupled to the output shaft of such oscillating power tools, such as such as oscillating saw blades, cutting blades, abrasives, sanding platens, pads and papers, rasps, and scrapers. Embodiments of oscillating tools and accessories include those disclosed in commonly-owned U.S. Patent Application Nos. 61/329,480 (filed Apr. 29, 2010), Ser. No. 12/942,098 (filed Nov. 9, 2010), and Ser. No. 13/044,811 (filed Mar. 10, 2011), each of which is incorporated by reference in their entirety.

### SUMMARY

In an aspect, a blade for use with an oscillating power tool includes a blade body having a front portion and a rear portion. A working portion is coupled to the front portion of the blade body and is configured to remove material from a workpiece. A tool attachment portion is coupled to a rear portion of the blade body and is configured to be removably attachable to an oscillating power tool. A vibration reduction member is coupled to the blade body and configured to dampen vibration in the blade body.

Implementations of this aspect may include one or more of the following features. The vibration reduction element may include a slot defined in the front end portion of the blade body.

A shape of the slot may include at least one of a wave-like curve, a circle, a semi-circle, an oval, a parabola, a square, a rectangular, and a polygon. The vibration reduction element may include a dampening material received in the slot. The dampening material may include at least one of rubber, plastic, foam, and an elastomeric material. The working portion may include a plurality of teeth. The tool attachment portion may include a plurality of openings configured to couple the blade body to an oscillating power tool. The front portion generally may define a first plane and the rear portion generally may define a second plane that is offset from the first plane. The blade body may include an intermediate portion extending at an angle between the rear portion and the front portion. The vibration reduction member may include a snubbing finger having a first end removably couplable to an oscillating power tool housing, and a second end that applies a dampening force to the front end portion of the blade body. The vibration reduction member may include a stiffening plate coupled to the blade body. The stiffening plate may be L-shaped with one end coupled to the rear portion and another end coupled to the front portion.

In another aspect, a blade for use with an oscillating power tool may include a blade body having a front portion and a rear portion. A cutting edge may be coupled to the front portion of the blade body. A plurality of openings may be formed in the rear portion of the blade body. The plurality of openings may be configured to removably attach the blade body to an oscillating power tool. A slot may be defined in the front end portion of the blade body. The slot may be at least partially filled with vibration dampening material to dampen vibrations in the blade body.

Implementations of this aspect may include one or more of the following features. A shape of the slot may include at least one of a wave-like curve, a circle, a semi-circle, an oval, a parabola, a square, a rectangular, and a polygon. The dampening material may include at least one of rubber, plastic, foam, and an elastomeric material.

In an aspect, an accessory for use with an oscillating power tool includes a working end portion having a cutting edge, and a rear end portion configured to be removably attachable to an oscillating power tool. A depth stop portion is coupled to the working end portion and configured to limit a depth of penetration of the cutting edge into a workpiece.

Implementations of this aspect may include one or more of the following features. The cutting edge may have a plurality of teeth. The rear end portion may have a plurality of openings configured to receive an attachment mechanism of an oscillating power tool. An intermediate portion may join the working end portion to the rear end portion so that the working end portion is in a plane that is offset from a plane containing the rear end portion. The depth stop portion may limit the depth of penetration in generally a longitudinal direction relative to the working end portion. The depth stop portion may limit the depth of penetration in generally transverse to the working end portion. The depth stop portion may include a depth stop pin received in a hole in the working end portion. The depth stop portion may include an intermediate wall joining the working end portion and the rear end portion, the intermediate wall disposed in a plane at an angle to the working end portion to limit the depth of penetration of the working end portion. The working end portion, the rear end portion, and the intermediate portion generally may have a configuration similar to a top hat. The depth stop portion may include an offset registration arm coupled to and offset from the working end portion.

In another aspect, an accessory for use with an oscillating power tool, includes a working end portion, and a rear end portion configured to be removably attachable to an oscillating power tool. A vibration reduction member coupled to the working end portion and configured to limit vibration in the working end.

Implementations of this aspect may include one or more of the following features. The vibration reduction element may include a snubbing finger assembly removably coupled at one end to an oscillating power tool housing, and having a blunt surface at another end to apply a damping force to the working end. The vibration reduction element may include a slot defined in the working end. A damping material may be received in the slot. The slot may have a curved shape.

In another aspect, an accessory for use in cutting round holes in a workpiece using an oscillating power tool includes a working end portion having a generally cylindrical or semi-cylindrical wall. At an end of the cylindrical or semi-cylindrical is a cutting edge with a generally circular or semi-circular configuration. A rear end portion is removably attachable to an oscillating power tool. An intermediate portion connects the working end portion and the rear end portion.

Implementations of this aspect may include one or more of the following features. The cutting edge may have a plurality of teeth. The rear end portion may include a plurality of openings configured to receive an attachment mechanism of an oscillating power tool. An axis of the working end portion may be generally parallel to a plane containing the rear end portion. An axis of the working end portion may be generally transverse to a plane containing the rear end portion.

These and other aspects and implementations are within the scope of the following claims.

### BRIEF DESCRIPTION OF THE DRAWINGS

FIG. 1A is a perspective view of an embodiment of an oscillating power tool and accessory.

FIG. 1B is a perspective view of a first embodiment of an oscillating accessory with a depth stop.

FIG. 1C is a perspective view of a second embodiment of an oscillating accessory with a depth stop.

FIG. 1D is a side view of the oscillating accessory of FIG. 1C.

FIG. 2 is a perspective view of a third embodiment of an oscillating accessory with a depth stop.

FIG. 3A is a perspective view of a fourth embodiment of an oscillating accessory with a depth stop.

FIG. 3B is a side view of the oscillating accessory of FIG. 3A.

FIG. 4 is a perspective view of an embodiment of an oscillating power tool, accessory, and a finger for vibration reduction.

FIG. 5 is a top view of an embodiment of an oscillating accessory with a slot for vibration reduction.

FIG. 6 is a perspective view of an embodiment of an oscillating accessory with a stiffening plate for vibration reduction.

FIG. 7 is a perspective view of an embodiment of an oscillating power tool and a mixing or vibrating accessory.

FIG. 8A is a perspective view of a first embodiment of an oscillating holesaw accessory.

FIG. 8B is a perspective view of a second embodiment of an oscillating holesaw accessory.

### DETAILED DESCRIPTION OF THE DRAWINGS

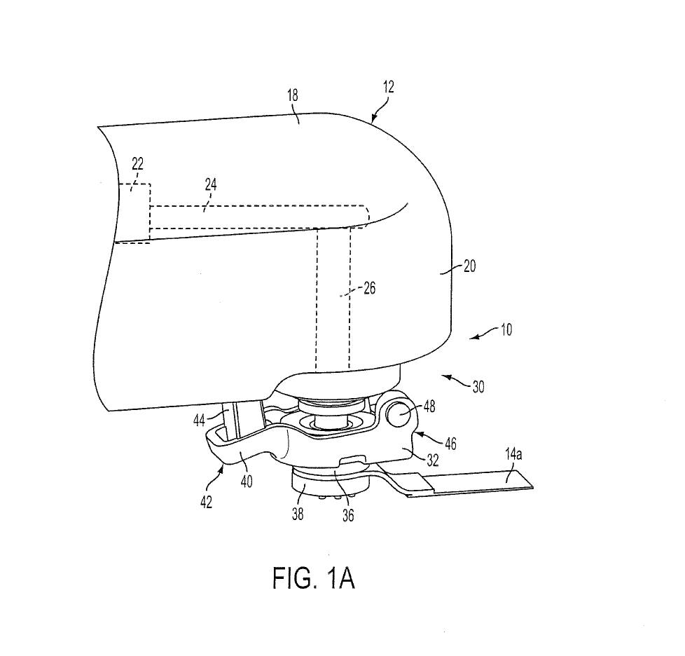

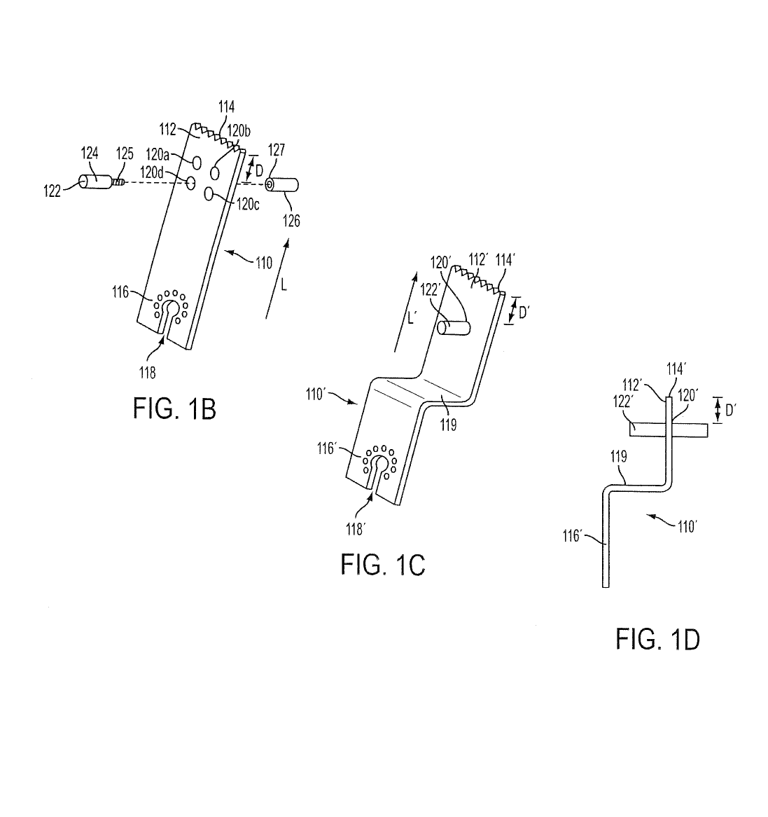

Referring to FIG. 1A, an oscillating power tool 12 includes a tool body 18 including a housing 20 that generally contains a motor 22 that drives an output member 24. The output member 24 can be coupled to an output spindle 26. The exemplary power tool 12 is configured for providing an oscillating motion onto the spindle 26. Coupled to the output spindle 26 is an attachment mechanism 10 for releasably securing multiple different accessories (such as a saw blade 14a) to the spindle 26, so that the oscillating motion of the spindle 26 transmits oscillating motion to the accessory 14a.

In one embodiment, the attachment mechanism 10 comprises a quick-release clamp assembly 30. The clamp assembly 30 operatively cooperates with an actuator such as a lever 32. The clamp assembly 30 can generally include a first clamp member 36 and a second clamp member 38. The lever 32 can include a lever arm 40 that includes a user engagement portion 42 and a block 44. The lever 32 can further include a pivot portion 46 having a pivot axle 48. The lever 32 can be actuated to separate the first and second clamp members 36, 38 and enable an accessory 14a to be received therebetween. Further details on the clamp assembly can be found in the aforementioned U.S. Patent Application No. 61/329,480, Ser. Nos. 12/942,098, and 13/044,811.

Depth Stops for Oscillating Accessories

It can be desirable to limit the depth to which the oscillating accessories may enter a workpiece. In certain implementations, this can be achieved by depth stops coupled to oscillating accessories.

Referring to FIG. 1B, in one embodiment, an oscillating saw blade 110 includes a working end portion 112 having a cutting edge 114 with a plurality of teeth, and a rear end portion 116 defining a plurality of openings 118 configured in a pattern to couple the saw blade 110 to an oscillating power tool (not shown). Defined in the working end portion 112 are a plurality of depth stop holes 120a-120d, each located a different distance D from the cutting edge 114 in a longitudinal direction L. The holes 120a-120d are configured to removably receive a depth stop pin 122 The depth stop pin 122 includes a male pin portion 124 with a threaded end 125 that is received in a threaded bore 127 in a female pin portion 126. The pin 122 limits the depth D to which the cutting edge 114 of the blade 110 can penetrate the workpiece in the longitudinal direction L of the saw blade, thus limiting the depth of cut. The plurality of holes 120 enable the pin 120 to be placed at a plurality of distances from the cutting edge 114, providing a plurality of different depths of cut.

Referring to FIGS. 1C and 1D, in another embodiment, an oscillating saw blade 110′ includes a working end portion 112′ having a cutting edge 114′ with a plurality of teeth, and a rear end portion 116′ defining a plurality of openings 118′ configured in a pattern to couple the saw blade 110′ to an oscillating power tool (not shown). The saw blade 110′ differs from the saw blade 110 of FIG. 1B in two respects. First, the working end portion 112′ lies in a plane that is different, and in this example, parallel to a plane that contains the rear end portion 116′. The working end portion 112′ and rear end portion 116′ are connected by an intermediate portion 119. As illustrated, the intermediate portion 119 is approximately perpendicular to the working end portion 112′ and the rear end portion 116′, although it should be understood that the angles between the working end portion 112′ and the intermediate portion 119, and between the intermediate portion 119 and the rear end portion 116′ may be different. Second, the working end 112′ defines a single depth stop hole 120′ for receiving a depth stop pin 122′, similar to depth stop pin 122 to limit the cutting depth D′ in a longitudinal direction L′ of the saw blade. It should be understood that the working end 112′ could include a plurality of depth stop holes for receiving the depth stop pin 122′ at different distances from the cutting edge 114′, thus providing a plurality of different depths of cut.

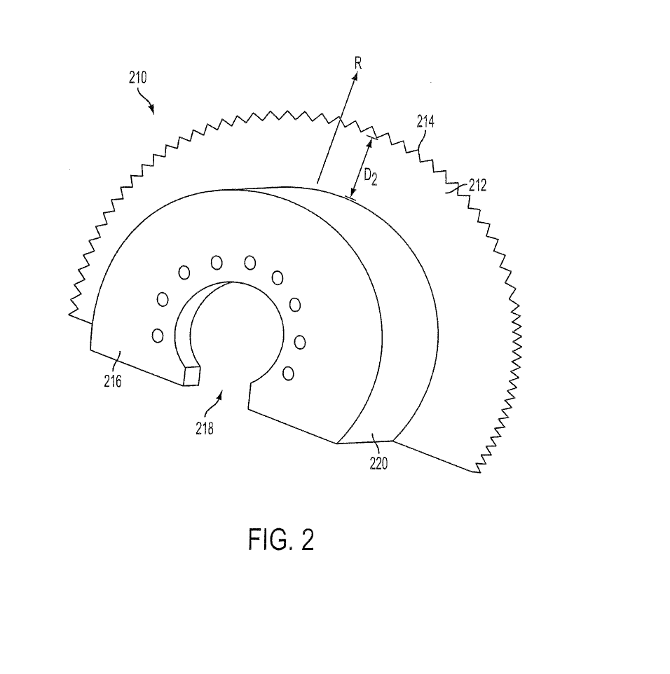

Referring to FIG. 2, in another embodiment, an oscillating saw blade 210 has a “top hat” configuration to limit a depth of cut of the saw blade. The blade 210 includes an arc-shaped working end portion 212 having an arc-shaped cutting edge 214 with a plurality of teeth. The blade also includes a semi-circular rear end portion 216 defining a plurality of openings 218 configured in a pattern to couple the saw blade 210 to an oscillating power tool (not shown). The working end portion 212 lies in a plane that is different, and in this example, generally parallel to, a plane that contains the rear end portion 216. The working end portion 212 and rear end portion 216 are connected by a generally semi-cylindrical intermediate wall 220. As illustrated, the intermediate wall 220 is approximately perpendicular to the working end portion 212 and the rear end portion 216, although it should be understood that the angles between the working end portion 212 and the intermediate wall 220, and between the intermediate portion 220 and the rear end portion 216 may be different. Thus, the blade 210 has an overall appearance similar to a portion of a top hat. The intermediate wall 220 functions as a depth stop, preventing the cutting edge 214 from penetrating the workpiece a distance greater than a distance D2 in a radial direction R of the saw blade.

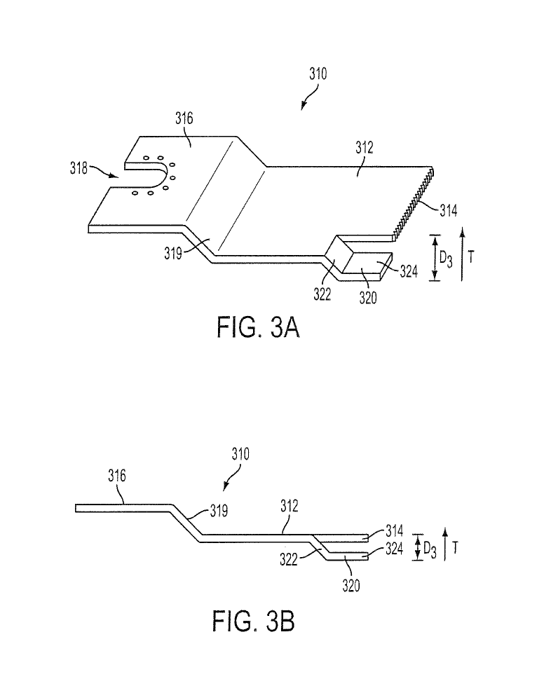

Referring to FIGS. 3A and 3B, in another embodiment, an oscillating saw blade 310 includes a working end portion 312 having a cutting edge 314 with a plurality of teeth, and a rear end portion 316 defining a plurality of openings 318 configured in a pattern to couple the saw blade 310 to an oscillating power tool (not shown). The working end portion 312 lies in a plane that is different, and in this example, parallel to a plane that contains the rear end portion 316. The working end portion 312 and rear end portion 316 are connected by an intermediate portion 319. As illustrated, the intermediate portion 319 is approximately perpendicular to the working end portion 312 and the rear end portion 316, although it should be understood that the angles between the working end portion 312 and the intermediate portion 319, and between the intermediate portion 319 and the rear end portion 316 may be different.

The working end 312 further includes an offset registration feature 320 that is offset from the working end 312 in a transverse direction T (e.g., perpendicular) to the working end portion 312. The registration feature 320 includes a first arm 322 that is connected to and depends downward from the working end portion 312 at an angle, and a second arm that is connected to and extends forward of the first arm 312 in a direction that is generally parallel to and offset from the working end portion 320. The registration feature 320 limits the cutting depth D3 of the cutting edge in the perpendicular direction P. In other embodiments, a saw blade could include the depth stop pins of one of FIGS. 1A-1C and the registration feature of FIGS. 3A-3B thus providing a saw blade that limits cutting depth in both the longitudinal direction L and the transverse direction T.

Vibration Reduction for Oscillating Accessories

It can also be desirable to reduce the amount of vibration in an oscillating saw blade when being used in an oscillating power tool.

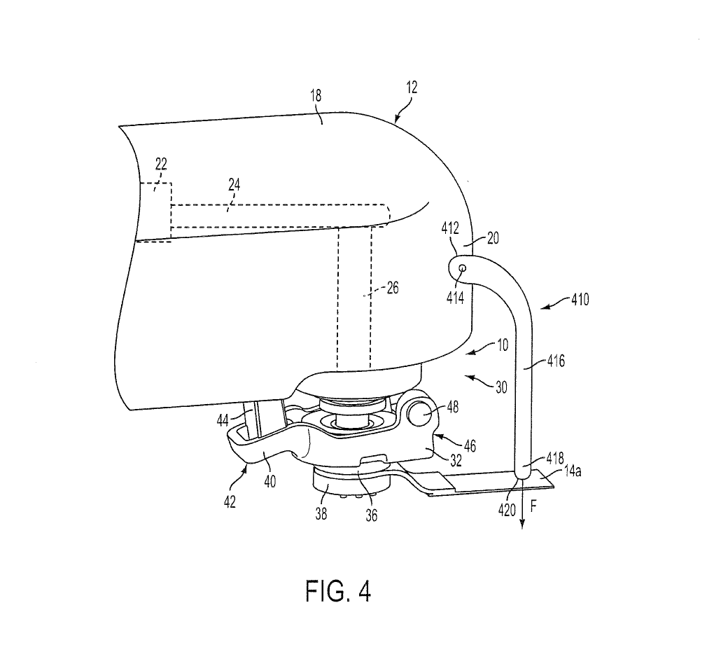

Referring to FIG. 4, in one embodiment, a snubbing finger assembly 410 may be removably attached to the housing 18 of the oscillating power tool 12 to reduce the amount of vibration in the accessory 14a. The snubbing finger assembly comprises a rigid or semi-rigid rod 416 having a first end portion 412 removably attachable to the housing 18 (e.g., by a removable bolt 414), and a second end portion 418 having a blunt tip 420. The blunt tip 420 exerts a downward force F on the accessory 14a, thus reducing movement and vibration of the accessory in the direction F outside of the plane of the cutting edge.

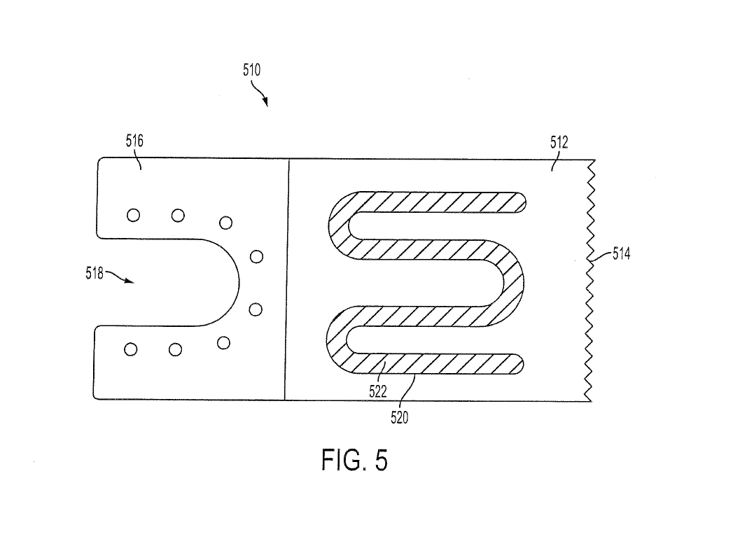

Referring to FIG. 5, in another embodiment, an oscillating saw blade 510 includes a working end portion 512 having a cutting edge 514 with a plurality of teeth, and a rear end portion 516 defining a plurality of openings 518 configured in a pattern to couple the saw blade 510 to an oscillating power tool. The working end portion 512 may be offset from the rear end portion 516 as previously described. The working end portion 512 defines a curvilinear shaped slot 520 and a dampening material (e.g., rubber, plastic, foam, and/or elastomeric material) received in the slot 520. The shape of the slot 520 and the amount and type of the dampening material 522 are selected to reduce vibrations in the saw blade 510. Although the slot 520 is illustrated as having a wave-like curved shape, it should be understood that the slot can have a wide variety of other shapes such as circular, semi-circular, oval, parabolic, square, rectangular, or polygonal. There may also be multiple connected or unconnected slots of various configurations.

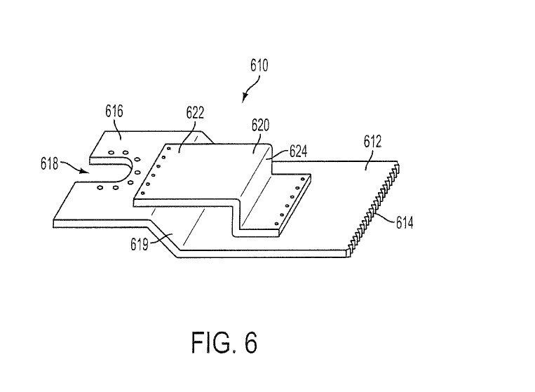

Referring to FIG. 6, in another embodiment, an oscillating saw blade 610 includes a working end portion 612 having a cutting edge 614 with a plurality of teeth, and a rear end portion 616 defining a plurality of openings 618 configured in a pattern to couple the saw blade 510 to an oscillating power tool. The working end portion 612 may be offset from the rear end portion 616 by an angled intermediate portion 619, as previously described. The oscillating saw blade 610 further includes an L-shaped stiffening plate 620 having a first end connected (e.g., by welding or brazing) to the rear end portion 616, and a second end 624 connected (e.g., by welding or brazing) to the underside of the working end portion 612. The stiffness of the stiffening plate 620 is selected so as to dampen vibrations in the working end portion 612 of the saw blade 610.

Mixing or Vibrating Accessory

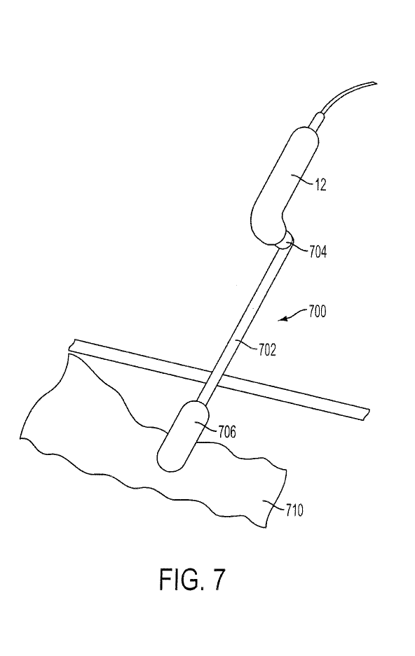

Referring to FIG. 7, a mixing or vibrating accessory 700 can be coupled to an oscillating power tool 12 to enable using the tool to mix liquids such as paint or drywall mud, or to vibrate concrete. The mixing or vibrating accessory 700 that includes a flexible cable 702 having at one end to an attachment portion 704 for coupling the accessory to the attachment mechanism 10 of the oscillating power tool 12. The opposite end of the cable 702 is connected to a vibrating or mixing element 706. The mixing or vibrating accessory 700 converts the oscillating output motion of the power tool 12 to a vibrating motion of the accessory 700 to mix or vibrate a liquid or semi-liquid material 710 such as paint, drywall mud, or wet concrete.

Holesaw Accessory

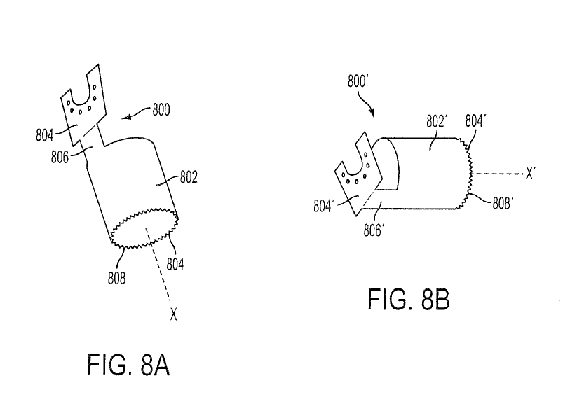

FIGS. 8A and 8B illustrate two embodiments of a holesaw cutting accessory 800, 800′ that can be coupled to an oscillating tool to facilitate cutting large round holes in a workpiece, similar to the cuts made by a holesaw attached to a drill. Each holesaw cutting accessory 800, 800′ includes a generally cylindrical working end portion 802, 802′ connected to a generally flat rear end portion 804, 804′ by an intermediate portion 806, 806′. Each working end portion 802, 802′ terminates in a generally circular cutting edge 808, 808′ having a plurality of teeth. It should be understood that the working end portion 802, 802′ and/or the cutting edge 808, 808′ may have the shape of a partial cylinder with a slot or a semi-circle, respectively. The rear end portion 804, 804′ defines a plurality of openings 810, 810′ configured to removably attach the holesaw cutting accessory 800, 800′ to the output of an oscillating power tool. In the embodiment of FIG. 8A, the rear end portion 804 lies in a plane that is generally parallel to a longitudinal axis X of the cylindrical working end portion 802. In the embodiment of FIG. 8B, the rear end portion 804′ lines in a plane that is generally perpendicular to a longitudinal axis X′ of the cylindrical working end portion 802′. In other embodiments, the rear end portion can be at other angles to the cylindrical working end portion. In further embodiments, the cylindrical portion may be semi-cylindrical and/or the cutting end may be semi-circular so that there is only a portion of the cylinder or circle. In use, the holesaw cutting accessories can be used to form large diameter round holes in a workpiece using an oscillating power tool.

Numerous modifications may be made to the exemplary implementations described above. These and other embodiments and modifications are within the scope of the following claims.

What is claimed is:

1. A blade for use with an oscillating power tool, the blade comprising:
a blade body having a front portion and a rear portion;
a working portion coupled to the front portion of the blade body, the working portion configured to remove material from a workpiece;
a tool attachment portion coupled to a rear portion of the blade body, the tool attachment portion configured to be removably attachable to an oscillating power tool; and
a vibration reduction member coupled to the blade body and configured to dampen vibration in the blade body.

2. The blade of claim 1, wherein the vibration reduction element comprises a slot defined in the front end portion of the blade body.

3. The blade of claim 2, wherein a shape of the slot comprises at least one of a wave-like curve, a circle, a semi-circle, an oval, a parabola, a square, a rectangular, and a polygon.

4. The blade of claim 2 wherein the vibration reduction element further comprises a dampening material received in the slot.

5. The blade of claim 4, wherein the dampening material comprises at least one of rubber, plastic, foam, and an elastomeric material.

6. The blade of claim 5, wherein the slot has a wave-like curve shape.

7. The blade of claim 1, wherein the working portion comprises a plurality of teeth.

8. The blade of claim 7, wherein the tool attachment portion comprises a plurality of openings configured to couple the blade body to an oscillating power tool.

9. The blade of claim 8, wherein the front portion generally defines a first plane and the rear portion generally defines a second plane that is offset from the first plane.

10. The blade of claim 1, wherein the vibration reduction member comprises a snubbing finger having a first end removably couplable to an oscillating power tool housing, and a second end that applies a dampening force to the front end portion of the blade body.

11. The blade of claim 1, wherein the vibration reduction member comprises a stiffening plate coupled to the blade body.

12. The blade of claim 11, wherein the front portion generally defines a first plane and the rear portion generally defines a second plane that is offset from the first plane.

13. The blade of claim 12, wherein the blade body further comprises an intermediate portion extending at an angle between the rear portion and the front portion.

14. The blade of claim 13, wherein the stiffening plate is L-shaped with one end coupled to the rear portion and another end coupled to the front portion.

15. A blade for use with an oscillating power tool, the blade comprising:
a blade body having a front portion and a rear portion;
a cutting edge coupled to the front portion of the blade body;
a plurality of openings formed in the rear portion of the blade body, the plurality of openings configured to removably attach the blade body to an oscillating power tool; and
a slot defined in the front end portion of the blade body, the slot at least partially filled with vibration dampening material to dampen vibrations in the blade body.

16. The blade of claim 15, wherein a shape of the slot comprises at least one of a wave-like curve, a circle, a semi-circle, an oval, a parabola, a square, a rectangular, and a polygon.

17. The blade of claim 15, wherein the dampening material comprises at least one of rubber, plastic, foam, and an elastomeric material.

18. The blade of claim 17, wherein the slot has a wave-like curve shape.
